(19) United States
(12) Patent Application Publication
(10) Pub. No.: US 2013/0156237 A1
(43) Pub. Date: Jun. 20, 2013

(54) HIGH POWER MICRO-SPEAKER

(71) Applicant: BUJEON CO., LTD., Ansan (KR)

(72) Inventor: Sung Sik KIM, Ansan (KR)

(73) Assignee: BUJEON CO., LTD., Ansan (KR)

(21) Appl. No.: 13/714,391

(22) Filed: Dec. 13, 2012

(30) Foreign Application Priority Data
Dec. 14, 2011 (KR) 10-2011-0134794

(51) Int. Cl. H04R 9/06

(52) U.S. Cl. CPC H04R 9/06
USPC 381/191

(57) ABSTRACT

Disclosed is a high power micro-speaker having a damper plate. More particularly, disclosed is a high power micro-speaker in which a damper plate has an opening through which a voice coil can pass, and the voice coil having passed through the opening is attached to a lower surface of a vibrating plate that is located above the damper plate, which provides an increased vibrating region. As such, enhanced output power of the micro-speaker is accomplished by increasing a height of the voice coil, or a slimmer design of the micro-speaker is accomplished by reducing a height of a frame.

### BACKGROUND OF THE INVENTION

1. Field of the Invention

The present invention relates to a high power micro-speaker having a damper plate, and more particularly to a high power micro-speaker in which a damper plate has an opening through which a voice coil can pass, and the voice coil having passed through the opening is attached to a lower surface of a vibrating plate that is located above the damper plate, which provides an increased vibrating region, whereby a height of the voice coil may be increased to enhance power, or a height of a frame may be reduced to achieve a slimmer design of the micro-speaker.

2. Description of the Related Art

In general, portable electronic appliances, such as portable mobile communication terminals, laptop computers, MP3 players, and earphones, for example, are equipped with micro-speakers that convert an electric signal into a sound signal.

Considering a configuration of conventional micro-speakers, a magnetic circuit is constructed using an upper plate and a magnet within a yoke member, and a voice coil is installed in an air gap to enable linkage of magnetic flux of the magnetic circuit. The voice coil is attached to a vibrating plate, and in turn the vibrating plate is attached to and restrained by a frame. Thus, as the voice coil generates vertical electromotive force upon receiving an input signal applied to the voice coil so as to vertically vibrate the vibrating plate, a sound pressure is created.

In the above described conventional micro-speakers, a damper plate is attached to the vibrating plate. The damper plate serves not only to stably hold the vibrating plate and the voice coil during vertical vibration of the vibrating plate, but also to limit the maximum amplitude of the vibrating plate to within an appropriate range, which contributes to acquisition of high power.

FIGS. 15 and 16 illustrate one example of conventional micro-speakers having a damper plate. As illustrated, the conventional micro-speaker, designated by reference numeral 1A, is configured in such a way that a damper plate 20 is attached to a lower surface of a vibrating plate 90 that consists of a center dome part 40 and an edge part 50, and in turn a voice coil 30 is attached to a lower surface of the damper plate 20. Accordingly, the conventional micro-speaker 1A contains a vibrating space A (hereinafter referred to as a ‘vibrating region’) between the damper plate 20 and an upper plate 63 of a magnetic field generator 60, the vibrating region A being required for vibration of the voice coil 30 or the damper plate 20. In this case, a thickness T of the damper plate 20 is not included in the vibrating region A.

Additionally, the conventional micro-speaker 1A is configured in such a way that an adhesive 95 is applied, by a constant thickness t, onto the lower surface of the damper plate 20 to attach the voice coil 30 to the damper plate 20. However, a height of an adhesive residue (pellets) on a lateral surface of the voice coil 30 as well as the thickness t of the applied adhesive 95 may disadvantageously reduce the vibrating region A required for vertical movement of the voice coil 30.

The vibrating region A is a region in which the voice coil 30 and the damper plate 20 perform free vertical vibration, and must have a sufficient volume to effectively realize high sound quality, in particular, low-pitched sound. For example, it is important for the vibrating region A to prevent the voice coil 30 or the damper plate 20 from colliding with the upper plate 63.

Accordingly, in the case of the conventional micro-speaker 1A, the vibrating region A must be designed in consideration of all of the thickness T of the damper plate 20 and the thickness t of the adhesive 95, and therefore it is necessary to increase the size of the micro-speaker 1A or to reduce the height of the voice coil 30 and/or a magnet 62. This results in a limit to acquisition of a high power or small thickness.

As illustrated in FIGS. 17 and 18, conventionally, a lead wire 31 of the voice coil 30 is interposed between the damper plate 20 and an upper surface of the voice coil 30, which makes it difficult for the voice coil 30 to be installed perpendicular to the damper plate 20. That is, the voice coil 30 may problematically be attached in a tilted state due to a height difference equivalent to a thickness of the lead wire 31 between an area where the lead wire 31 of the voice coil 30 passes and an area where the lead wire 31 of the voice coil 30 does not pass.

When the voice coil 30, which is installed to vertically vibrate in an air gap G formed in the magnetic field generator 60, is tilted, collision between the voice coil 30 and the magnetic field generator 60 may cause generation of collision sound or breakdown of the voice coil 30. Therefore, to prevent collision of the voice coil 30, the conventional micro-speaker 1A must be designed to have a large air gap G, and it is necessary to increase the size of the micro-speaker 1A or to reduce the size of the magnetic field generator 60. This consequently limits design of a high power slim micro-speaker.

In addition, as illustrated in FIG. 19, the conventional micro-speaker 1A is fabricated via the procedure of attaching the voice coil 30 to the lower surface of the damper plate 20, and thereafter connecting the lead wire 31 of the voice coil 30 to the lower surface of the damper plate 20. However, this procedure cannot be performed successively because connection of the lead wire 31 may require separation of the damper plate 20, to which the voice coil 30 is attached, from a jig 100 and then reversal of the damper plate 20, or must be performed in a reversed state of the jig 100. As a result, the conventional micro-speaker 1A suffers from complexity and automation difficulty in fabrication.

### SUMMARY OF THE INVENTION

Therefore, the present invention has been made in view of the above problems, and it is one object of the present invention to provide a high power slim micro-speaker.

It is another object of the present invention to provide a micro-speaker which ensures a simplified successive assembly process, thereby achieving ease in automation of fabrication.

It is another object of the present invention to provide a micro-speaker in which a voice coil is attached to a lower surface of a vibrating plate, more particularly, to a lower surface of a center dome part of the vibrating plate located above a damper plate, rather than being attached to a lower surface of the damper plate, which can provide a larger vibrating region required for vertical vibration of the voice coil.

It is another object of the present invention to provide a micro-speaker in which a damper plate is provided with an opening, through which a voice coil can pass, and the voice coil having passed through the opening is attached to a lower surface of a vibrating plate, more particularly, to a lower surface of a center dome part of the vibrating plate that is located above the damper plate, whereby an available space equivalent to a thickness of the damper plate is acquired and a height of the voice coil or a magnet can be increased as much as a height of the acquired space, resulting in a high power of the micro-speaker.

It is another object of the present invention to provide a micro-speaker, in which a damper plate is provided with an opening, through which a voice coil can pass, and the voice coil having passed through the opening is attached to a lower surface of a vibrating plate, more particularly, to a lower surface of a center dome part of the vibrating plate that is located above the damper plate, whereby an available space equivalent to a thickness of the damper plate is acquired and a height of a frame can be reduced as much as a height of the acquired space, resulting in a slim design of the micro-speaker.

It is another object of the present invention to provide a micro-speaker in which a damper plate is provided with an opening, through which a voice coil can pass, and the voice coil having passed through the opening is attached to a lower surface of a vibrating plate, more particularly, to a lower surface of a center dome part of the vibrating plate that is located above the damper plate such that an adhesive or adhesive residue applied between an upper surface of the voice coil and the vibrating plate has a thickness equal to or less than a thickness of the damper plate, which can prevent a reduction in a vibrating region and provide a high power slim micro-speaker.

It is a further object of the present invention to provide a micro-speaker and a method of fabricating the same, in which a damper plate is provided with an opening, through which a voice coil can pass, and a lead wire of the voice coil is attached to an upper surface of the damper plate by passing through the opening, whereby the voice coil can be vertically attached to the damper plate, and ease in automation of an assembly process can be accomplished.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a high power micro-speaker according to the present invention;

FIG. 2 is a sectional view illustrating an embodiment of the micro-speaker according to the present invention;

FIG. 3 is a sectional view illustrating another embodiment of the micro-speaker according to the present invention;

FIG. 4 is a partial enlarged view of the micro-speaker illustrated in FIG. 3;

FIG. 5 is an exploded perspective view of the micro-speaker illustrated in FIG. 3;

FIG. 6 is a sectional view illustrating an attachment configuration of the micro-speaker illustrated in FIG. 3;

FIG. 7 is a sectional view illustrating another embodiment of the micro-speaker according to the present invention;

FIG. 8 is a sectional view illustrating a further embodiment of the micro-speaker according to the present invention;

FIG. 9 is an enlarged sectional view of the micro-speaker illustrated in FIG. 8;

FIG. 10 is a sectional view illustrating a connection configuration for a lead wire of a voice coil according to the present invention;

FIG. 11 is an explanatory view illustrating a method of connecting the lead wire of the voice coil through a lead wire hole formed in a center dome part of a vibrating plate according to the present invention;

FIG. 12 is a flowchart illustrating an assembly method of the micro-speaker according to the present invention;

FIG. 13 is an exploded perspective view illustrating a vibrating module that consists of a damper plate, a voice coil, and a center dome part of a vibrating plate;

FIG. 14 is a view illustrating the sequence of an assembly method of the vibrating module according to the present invention;

FIG. 15 is a sectional view illustrating an example of a conventional micro-speaker;

FIG. 16 is a partial enlarged view of the conventional micro-speaker illustrated in FIG. 15;

FIG. 17 is a sectional view illustrating a connection configuration for a lead wire of a voice coil included in the conventional micro-speaker;

FIG. 18 is a sectional view illustrating the voice coil of the conventional micro-speaker, which is installed in a tilted state with respect to a damper plate; and

FIG. 19 is a view illustrating the sequence of an assembly method of a vibrating module included in the conventional micro-speaker.

### DETAILED DESCRIPTION OF THE INVENTION

Hereinafter, a high power micro-speaker according to the present invention will be described in more detail with reference to the accompanying drawings. In the following description of the present invention, the same constituent elements as those of the previously described conventional micro-speaker will be designated by the same reference numerals, and a detailed description thereof will be omitted.

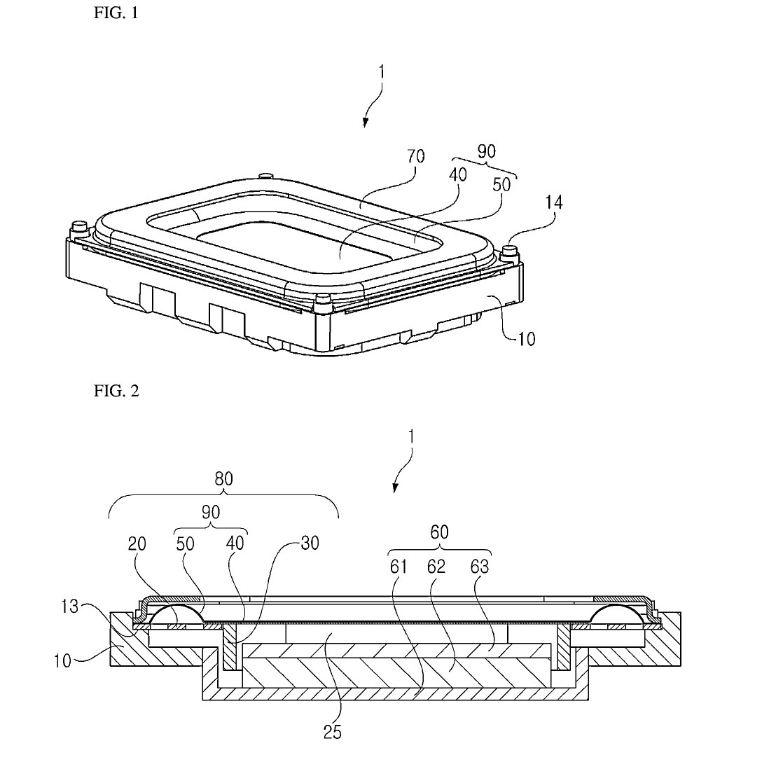

FIGS. 1 and 2 illustrate an embodiment of a high power micro-speaker (hereinafter briefly referred to as a ‘micro-speaker’) according to the present invention.

As illustrated in the drawings, the micro-speaker, designated by reference numeral 1, according to the present invention includes a frame 10 having a small thickness. The frame 10 is vertically perforated to have open upper and lower ends. Accommodated in the frame 10 are a vibrating plate 90, a voice coil 30, and a magnetic field generator 60 that consists of an upper plate 63, a magnet 62, and a lower plate 61. The lower plate 61 may be replaced by a cylindrical yoke. In this case, the vibrating plate 90 may consist of a center dome part 40 and an edge part 50 integrally formed with an edge of the center dome part 40.

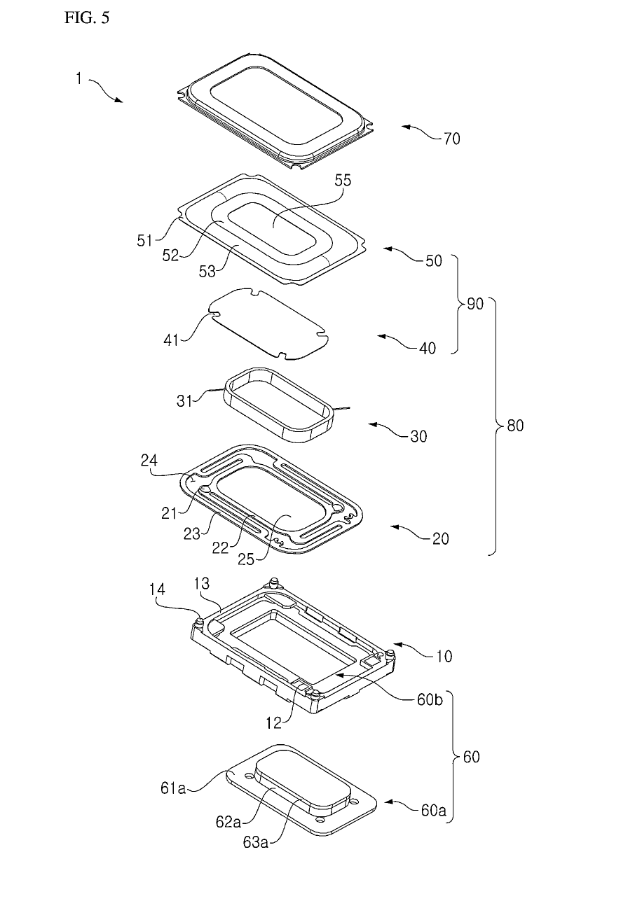

FIG. 2 is a sectional view of the micro-speaker 1 according to the present invention. As illustrated, the micro-speaker 1 includes a damper plate 20 located between the vibrating plate 90 and the upper plate 63. The damper plate 20 may be a metal plate or a soft circuit board. The damper plate 20 has an aperture 24 or a bridge to achieve a predetermined magnitude of elasticity. An outer peripheral end (23, see FIG. 5) of the damper plate 20 is secured to the frame 10, and an inner peripheral end (22, see FIG. 5) of the damper plate 20 is secured to the vibrating plate 90.

The damper plate 20 serves not only to stably support the vibrating plate 90 during vibration thereof, but also to transmit an electric control signal applied from an external source to the voice coil 30. To this end, the damper plate 20 may be formed of a conductive metal, or may be prepared as a printed circuit board having a predetermined circuit pattern.

The frame 10 has a stepped portion 13 such that the damper plate 20 is seated on the stepped portion 13. A connection terminal 12 is provided on the stepped portion 13 for the damper plate 12, to apply the electric control signal from the external source to the damper plate 20.

The vibrating plate 90, the damper plate 20, and the voice coil 30 included in the micro-speaker 1 are assembled to one another to construct a vibrating module 80. The vibrating module 80 is installed above the magnetic field generator 60. As the vibrating module 80 vertically vibrates via interaction with the magnetic field generator 60, sound is generated. To this end, a vibrating region A having a predetermined height is required between the vibrating module 80 and the magnetic field generator 60.

The micro-speaker 1 according to the present invention has features in that the vibrating module 80 has an improved configuration suitable to achieve a larger vibrating region A and to ensure easier assembly thereof and consequently enhanced productivity.

The damper plate 20 according to the present invention has a center opening 25 having a predetermined size. The voice coil 30 is sized to vertically pass through the opening 25. That is, the voice coil 30 may penetrate the damper plate 20 through the opening 25. Accordingly, a diameter of the voice coil 30 is less than a diameter of the opening 25.

The inner peripheral end 22 of the damper plate 20 is secured to a lower surface of the vibrating plate 90. The vibrating plate 90 is located above the opening 25 of the damper plate 20. As such, the damper plate 20 and the vibrating plate 90 are integrally coupled to each other so as to vibrate together.

The voice coil 30 having passed through the opening 25 is attached to the lower surface of the vibrating plate 90. That is, according to the present invention, an upper surface of the voice coil 30 is attached to the lower surface of the vibrating plate 90. As such, if the voice coil 30 vibrates via interaction between the magnetic field generator 60 and the voice coil 30, the vibrating plate 90 and the damper plate 20 also vibrate together, causing generation of sound.

As described above, in the present invention, the voice coil 30 is not attached to a lower surface of the damper plate 20, but penetrates the damper plate 20 and is attached to the lower surface of the vibrating plate 90 located above the damper plate 20. As such, the vibrating region A, in which the voice coil 30 is movable, may be increased in volume by a thickness T of the damper plate 20.

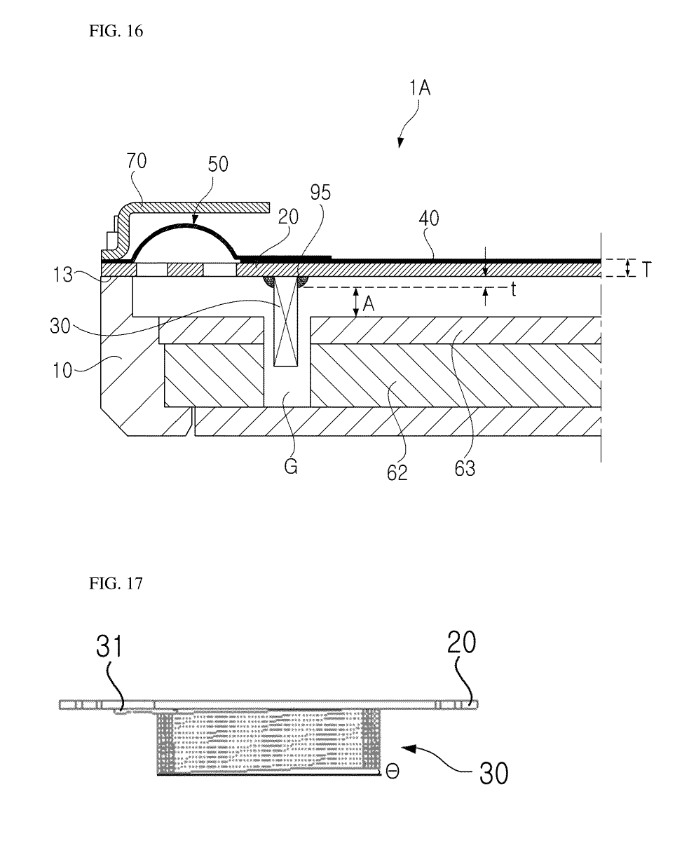

On the other hand, as illustrated in FIGS. 15 and 16, the previously described conventional micro-speaker 1A is configured such that the upper surface of the voice coil 30 is attached to the lower surface of the damper plate 20. Also, the conventional damper plate 20 has no center opening. Moreover, even if the damper plate 20 has the opening, the opening 25 may have an insufficient size for passage of the voice coil 30. Accordingly, the conventional micro-speaker 1A has a smaller vibrating region A than the vibrating region in the present invention by the thickness T of the damper plate 20. In addition, the conventional voice coil 30 causes a reduction in the vibrating region A, in which the damper plate 20 can vibrate, by the thickness t of the applied adhesive or the thickness of the adhesive residue (pellet) as described above.

Accordingly, in the case of the conventional micro-speaker 1A, it may be necessary to reduce the height of the voice coil 30 or to increase the height of the frame 10 by the thickness T of the damper plate 20 and the thickness t of the adhesive. This limits the number of turns of the voice coil 30, causing deterioration in the power of the micro-speaker 1A or increase in the size of the micro-speaker 1A. Consequently, the conventional micro-speaker 1A cannot meet the recent tendency of higher performance and smaller size of portable sound appliances.

In the micro-speaker 1 according to the present invention, instead of being attached to the damper plate 20, the voice coil 30 is configured to penetrate the damper plate 20 and be attached to the vibrating plate 90 located above the damper plate 20. With this attachment configuration, it is possible to increase the volume of the vibrating region A by the thickness T of the damper plate 20 and the thickness t of the conventionally used adhesive. Accordingly, the micro-speaker 1 according to the present invention can achieve a smaller thickness by reducing the height of the frame 10 assuming that the same power is maintained. Also, assuming that the frame 10 maintains the same height, the micro-speaker 1 according to the present invention can achieve high output power by increasing the height of the voice coil 30 or the magnet 62, i.e. by increasing the number of turns of the voice coil 30 or the magnetic charge.

Meanwhile, the vibrating plate 90 according to the present invention is configured to effectively transfer vibration of the voice coil 30. Preferably, the vibrating plate 90 of the micro-speaker 1 according to the present invention consists of the center dome part 40 and the edge part 50. The center dome part 40 may be formed of a harder material than the edge part 50 or the previously described conventional center dome part, in order to ensure more efficient transfer of vibration of the voice coil 30. Also, an inner peripheral end (52, see FIG. 5) of the edge part 50 is secured to the edge of the center dome part 40, and an outer peripheral end (51, see FIG. 5) of the edge part 50 is secured to the frame 10.

The center dome part 40 is not always limited to a dome shape. As illustrated, according to the present invention, the center dome part 40 may have a flat plate shape. Alternatively, the center dome part 40 may include an upwardly raised dome portion 43. The dome portion 43 may have an angled shape or a rounded shape. A rim 45 for attachment of the edge part 50 or the damper plate 20 is formed at an edge of the dome portion 43.

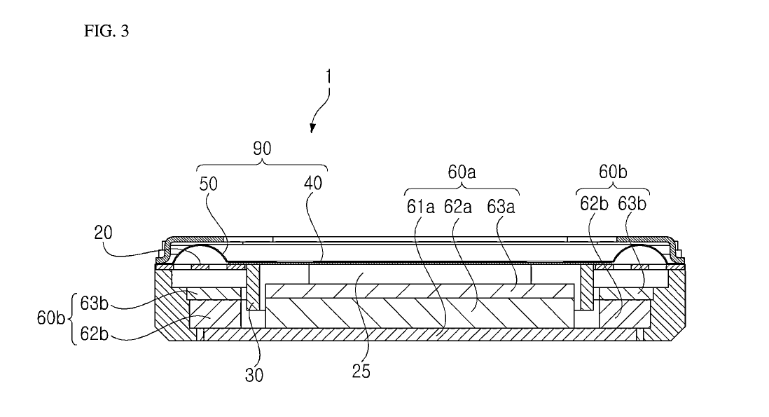

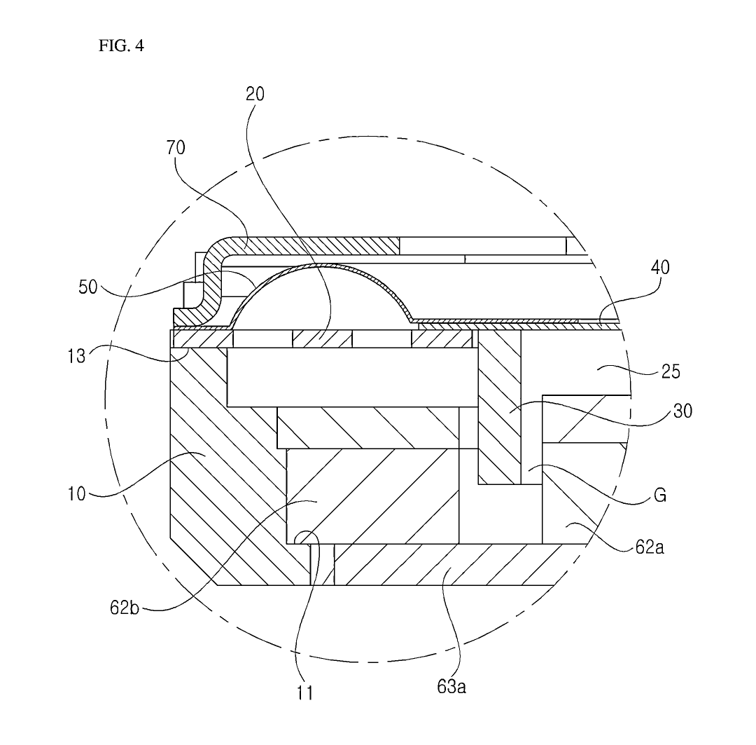

Next, FIGS. 3, 4 and 5 are respectively a sectional view, an enlarged sectional view and an exploded perspective view illustrating another embodiment of the micro-speaker 1 according to the present invention.

As illustrated, the micro-speaker 1 according to the present invention is configured such that the damper plate 20 has the opening 25 and the voice coil 30 is inserted into the opening 25. That is, the voice coil 30 is directly attached to a lower surface of the center dome part 40 rather than being attached to the lower surface of the damper plate 20. The edge part 50 is placed above the damper plate 20 so as to close the aperture 24 of the damper plate 20.

The outer peripheral end 51 of the edge part 50 and the outer peripheral end 23 of the damper plate 20 are secured to the frame 10, and the magnetic field generator 60 is secured to a bottom surface of the frame 10. The frame 10 is vertically perforated to have open upper and lower ends, and is provided at the upper end thereof with the stepped portion 13 to which the damper plate 20 is secured. The connection terminal 12 is installed at one side of the stepped portion 13 for the damper plate 20 and serves to transmit the electric control signal applied from the external source to the damper plate 20. Reference numeral 14 designates a cover coupling protrusion to guide the edge part 50 and a cover 70.

The magnetic field generator 60 according to the present embodiment consists of an inner magnetic unit 60a and an outer magnetic unit 60b. The inner magnetic unit 60a consists of an upper plate 63a, a magnet 62a, and a lower plate 61a. The inner magnetic unit 60a is inserted into the frame 10 through the open lower end of the frame 10. The frame 10 is provided at the open lower end thereof with a stepped portion 11 for the outer magnetic unit 60b such that the outer magnetic unit 60b is seated on the stepped portion 11 of the frame 10. The outer magnetic unit 60b consists of an upper plate 63b and a magnet 62b. An air gap G is formed between the inner magnetic unit 60a and the outer magnetic unit 60b.

The center dome part 40 has a plurality of lead wire holes 41 formed at an outer periphery thereof, through which a lead wire 31 of the voice coil 30 passes. The lead wire hole 31 of the voice coil 30, attached to the lower surface of the center dome part 40 of the vibrating plate 90, passes through the lead wire hole 41 so as to be exposed upward from the vibrating plate 90.

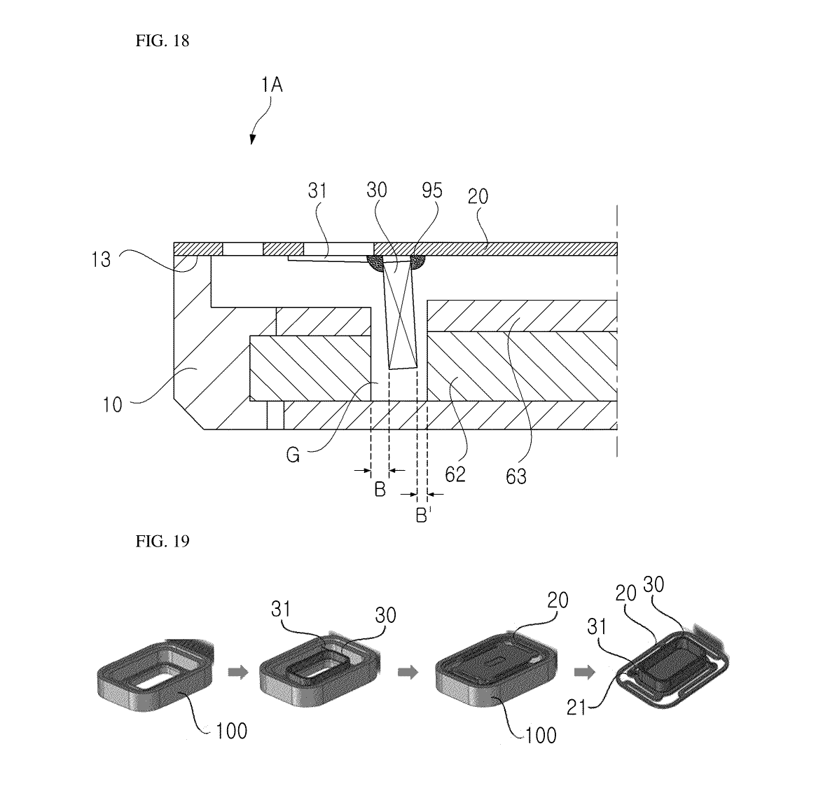

More specifically, in the case of the conventional micro-speaker 1A, as illustrated in FIGS. 17 and 18, the lead wire 31 is interposed between the upper surface of the voice coil 30 and the damper plate 20 as the voice coil 30 is attached to the lower surface of the damper plate 20. This causes the voice coil 30 to be tilted by an angle θ corresponding to the thickness of the lead wire 31, rather than being vertically attached to the damper plate 20, due to a height difference between an area where the lead wire 31 of the voice coil 30 passes and an area where the lead wire 31 of the voice coil 30 does not pass. When the voice coil 30 is tilted, the voice coil 30 cannot be located in the center of the air gap G (B≠B′), which causes collision between the voice coil 30 and the sidewall of the air gap G during vertical vibration of the voice coil 30. For this reason, the conventional micro-speaker 1A has a need for a sufficiently large size of air gap in consideration of the above described problem, which may problematically reduce the size of the magnet 62 or increase the size of the micro-speaker 1A.

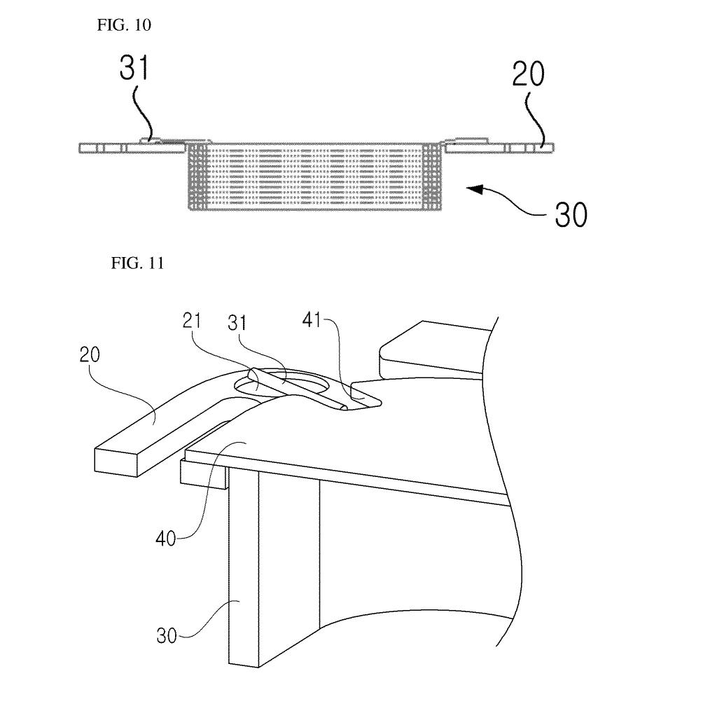

On the other hand, in the micro-speaker 1 according to the present invention, as illustrated in FIGS. 10 and 11, the plurality of lead wire holes 41 is formed in the edge of the center dome part 40 and the lead wire 31 of the voice coil 30 is pulled upward from the damper plate 20 through the lead wire holes 41 so as to be connected to a connection pad 21 that is provided on an upper surface of the damper plate 20. With this configuration, the lead wire 31 is not interposed between the voice coil 30 and the center dome part 40 and can always be attached vertically to the center dome part 40. Accordingly, according to the present invention, the voice coil 30 is located in the center of the air gap G and does not cause collision within the air gap G during vibration of the voice coil 30. Thus, reduction in the size of the air gap G is possible, which enables use of an increased size of the magnet, resulting in high power.

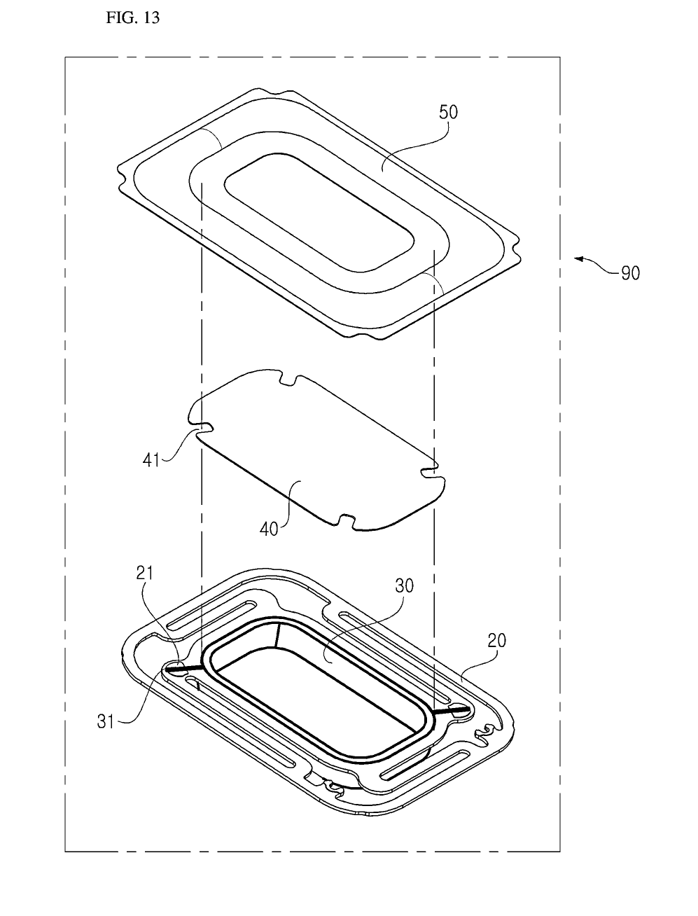

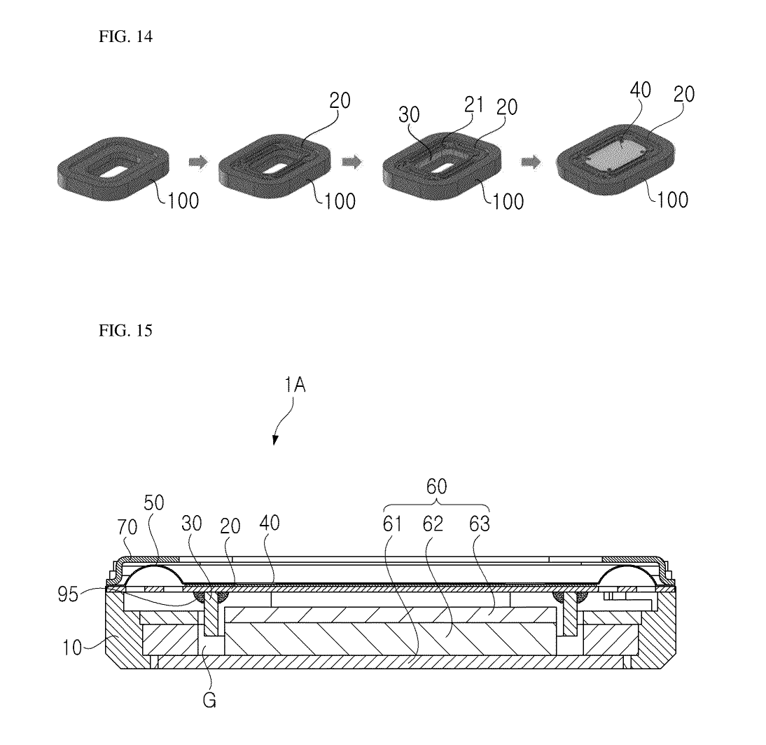

In addition, according to the present invention, the lead wire 31 of the voice coil 30 is connected to the upper surface of the damper plate 20, which results in a simplified assembly process of the vibrating module 80. More specifically, as illustrated in FIGS. 13 and 14, in the micro-speaker 1 according to the present invention, the vibrating module 80, which consists of the damper plate 20, the center dome part 40 of the vibrating plate 90, and the voice coil 30, is assembled as the aforementioned constituent elements are sequentially stacked one above another on a jig 100 (or the frame 10), and then the lead wire 31 of the voice coil 30 is directly connected to the upper surface of the damper plate 20. In this way, the assembly process can be successively performed without requiring separation of the damper plate 20 from the jig 100 or reversal of the damper plate 20, resulting in enhanced efficiency of fabrication and ease in automation of fabrication.

On the other hand, as illustrated in FIG. 19, the conventional micro-speaker 1A requires connection of the lead wire 31 of the voice coil 30, attached to the lower surface of the damper plate 20, to the lower surface of the damper plate 20. Accordingly, in order to solder the lead wire 31 to the damper plate 20, it is necessary to separate the damper plate 20, to which the voice coil 30 is attached, from the jig 100 and to reverse the damper plate 20, which makes it difficult to successively implement the assembly process.

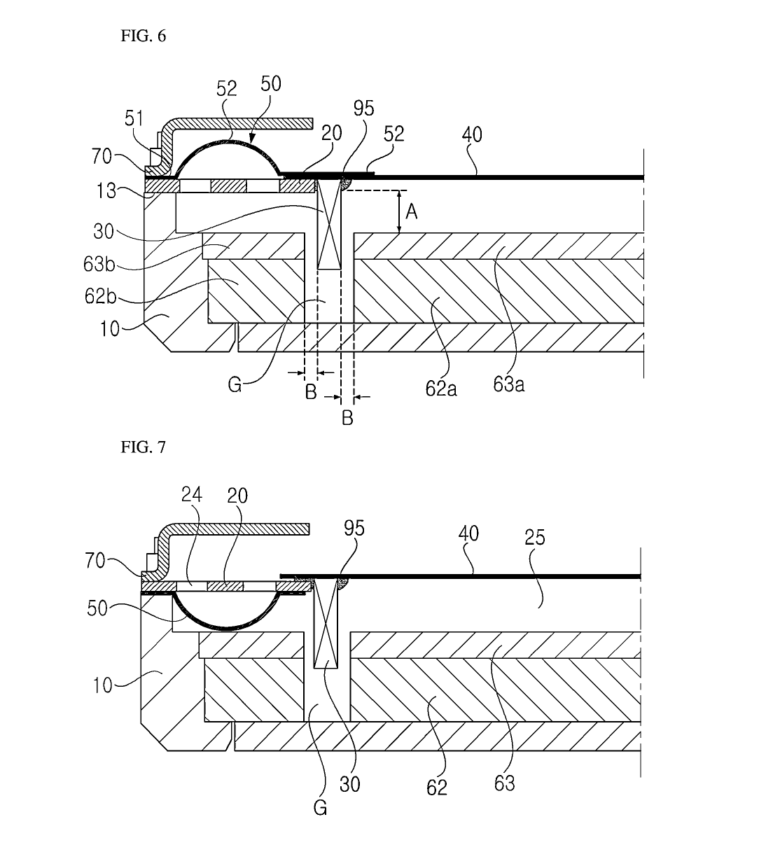

In addition, differently from the conventional micro-speaker 1A in which attachment of the voice coil 30 to the damper plate 20 is clearly independent of attachment of the center dome part 40 to the damper plate 20, in the assembly method of the vibrating module 80 according to the present invention, once the voice coil 30 passes through the opening 25 of the damper plate 20, an adhesive is applied to the upper surface of the voice coil 30 or between the upper surface of the voice coil 30 and the damper plate 20. Thereafter, when pressure is applied to the center dome part 40 that is placed over the voice coil 30 and the damper plate 20, the damper plate 20 and the center dome part 40 are attached to each other by the adhesive pushed out from the upper surface of the voice coil 30. Simultaneously, as the adhesive moves between the voice coil 30 and the damper plate 20, an outer peripheral surface of the voice coil 30 can be attached to an inner peripheral surface of the opening 25 of the damper plate 20 by the adhesive (see FIGS. 6 and 7). That is, according to the present invention, through a single adhesive operation, attachment between the voice coil 30 and the center dome part 40, attachment between the voice coil 30 and the damper plate 20, and attachment between the damper plate 20 and the center dome part 40 can simultaneously be accomplished, which has effects of simplifying the assembly process or realizing more strong attachment.

FIG. 7 illustrates another embodiment of the micro-speaker according to the present invention. In the micro-speaker 1 according to the present embodiment, the edge part 50 is located below the damper plate 20. That is, the outer peripheral end 51 of the edge part 50 is secured to the frame 10 and the inner peripheral end 52 of the edge part 50 is attached to the lower surface of the damper plate 20. In such an attached state, the edge part 50 closes the aperture 24 of the damper plate 20 and the center dome part 40 closes the opening 25 perforated in the damper plate 20, which can ensure efficient generation of sound waves during vibration.

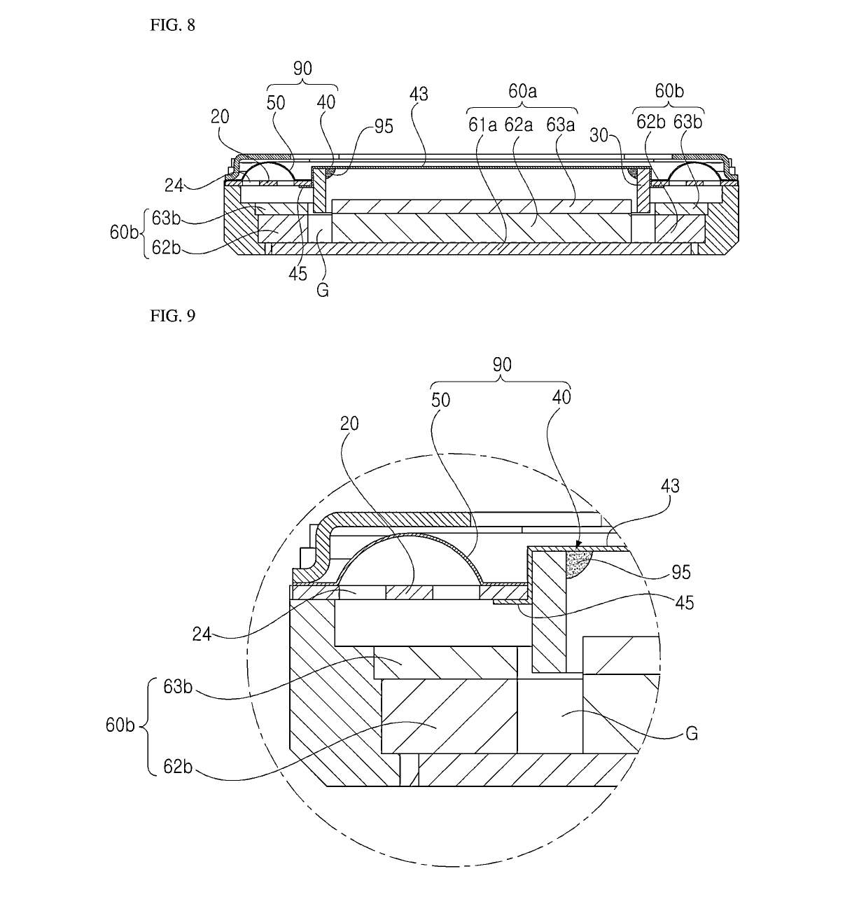

Next, FIGS. 8 and 9 are sectional views illustrating a further embodiment of the micro-speaker according to the present invention. As illustrated, the rim 45 of the center dome part 40 is attached to the lower surface of the damper plate 20 along the inner periphery of the opening 25. To this end, the dome portion 43 of the center dome part 40 has a sufficient shape and size to pass through the opening 25 of the damper plate 20, whereas the rim 45 has a shape and size unable to pass through the opening 25. That is, the dome portion 43 of the center dome part 40 passes through the opening 25 to protrude upward from the damper plate 20, and an adhesive is applied to the rim 45 to attach the rim 45 to the lower surface of the damper plate 20.

In the present embodiment, the voice coil 30 may be installed at a higher position regardless of a position of the damper plate 20. That is, the upper surface of the voice coil 30 may be attached to a lower surface of the upwardly protruding dome portion 43 so as to be located at a higher position than the upper surface of the damper plate 20. This allows an increase in the size of the voice coil 30, and consequently maximized power of the micro-speaker 1.

As will be understood from the above described embodiments, when the upper surface of the voice coil 30 is attached to the lower surface of the vibrating plate 90, more particularly, to the lower surface of the center dome part 40, the vibrating region A for the voice coil 30 may be increased by the thickness of the damper plate 20, which provides the following effects.

Firstly, since the voice coil 30 can be installed at a higher position than the previously described conventional one, it is possible to increase the number of turns of the voice coil 30 or to increase the size of the magnetic field generator 60. Assuming that the thickness of the damper plate 20 is in a range of 0.15 mm to 0.2 mm, an installation height of the magnetic field generator 60 may be increased by about 0.15 mm to 0.2 mm, which may result in greater sound pressure of the micro-speaker 1. For example, if the thickness of the magnetic field generator 60 is increased by 0.15 mm to 0.2 mm on the basis of the micro-speaker having a thickness of 3.5 mm, the sound pressure may be increased at least by 1.5dB to 2dB.

Secondly, the micro-speaker 1 may be fabricated with a reduced thickness owing to an increased vibrating region. That is, it is possible to fabricate a slimmer design of the micro-speaker 1 even while maintaining the same performance. For example, as compared to the aforementioned thickness of 3.5 mm, the micro-speaker 1 of the present invention may have a reduced thickness of 3.3 mm.

Thirdly, as compared to a configuration of conventional micro-speakers having the same size, the micro-speaker 1 of the present invention can increase a height of the vibrating region, in which the damper plate 20 is movable, by 0.15 mm to 0.2 mm. Therefore, resonance frequency F₀ between the natural frequency of a speaker material and external force (electric energy) can cover even a low-pitched range. That is, the present invention can provide even a low-pitched frequency of sound as well as an existing frequency range of sound.

The vibrating module 80 according to the present invention may be realized via a more simplified process than the conventional vibrating module.

Hereinafter, an assembly method of the micro-speaker according to the present invention will be described in brief.

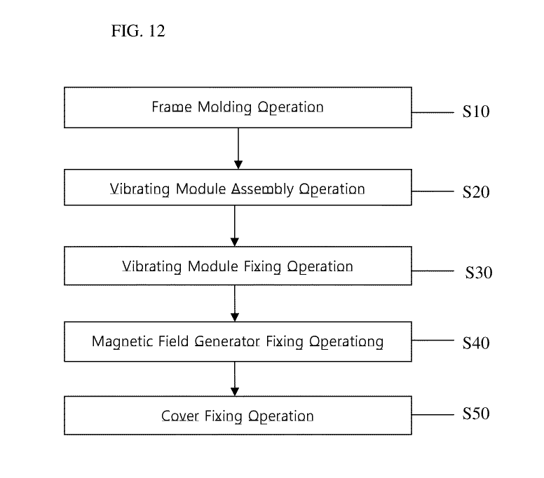

Referring to FIGS. 12 and 14, the method of fabricating the micro-speaker according to the present invention may basically include a frame molding operation S10, a vibrating module assembly operation S20, a vibrating module fixing operation S30, a magnetic field generator fixing operation S40, and a cover fixing operation S50.

The molding operation S10 is an operation of molding the frame 10 having open upper and lower ends, the frame 10 being provided with the cover coupling protrusions 14, the stepped portion 13 for the damper plate 20, and the stepped portion 11 for the outer magnetic unit 60b. The connection terminal 12 is installed to the stepped portion 13 for the damper plate 20. The frame 10 may have various shapes, such as a polygonal shape, circular shape, or elliptical shape, for example.

Next, the vibrating module assembly operation S20 includes mounting the damper plate 20 to the jig 100, inserting the voice coil 30 through the opening 25 of the damper plate 20, applying the adhesive to the upper surface of the voice coil 30 and the upper surface of the damper plate 20, placing the center dome part 40 or the edge part 50 over the adhesive, and applying pressure to the center dome part 40 or the edge part 50 so as to attach the center dome part 40 or the edge part 50 to the voice coil 30 or the damper plate 20.

In this case, the upper surface of the voice coil 30 having passed through the opening 25 of the damper plate 20 may be located on the same plane as the upper surface of the damper plate 20, or may protrude upward from the upper surface of the damper plate 20. In particular, when the upper surface of the voice coil 30 and the upper surface of the damper plate 20 are on the same plane, attachment between the center dome part 40, the damper plate 20 and the voice coil 30 may be accomplished via a single attachment process.

Meanwhile, as the lead wire 31 of the voice coil 30 is pulled upward through the lead wire hole 41 formed in the center dome part 40 to thereby be connected to the connection pad 21 provided on the upper surface of the damper plate 20, the assembly process of the vibrating module 80 is completed.

Then, the vibrating module 80 assembled as described above is fixed to the frame 10. That is, the outer peripheral end of the damper plate 20 is fixed to the stepped portion 13 for the damper plate 20 formed at the frame 10. As necessary, prior to installing the vibrating module 80, the outer magnet unit 60b may be installed to the stepped portion 11 for the outer magnet unit 60b formed at the frame 10.

Next, the magnetic field generator fixing operation S40 includes inserting the inner magnet unit 60a, which consists of the upper plate 63a, the magnet 62a and the lower plate (or yoke) 61a, into the frame 10 through the open lower end of the frame 10.

Finally, the cover fixing operation S60 includes fixing the cover 70 over the frame 10 to which the vibrating module 80 and the magnetic field generator 60 have been fixed. In this case, the cover 70 may be fixed via thermal fusion, for example.

In this way, with a configuration of the present invention in which the damper plate 20 has the opening 25 such that the voice coil 30 is inserted through the opening 25, the vibrating module 80 can be assembled via a simplified process and can be more firmly coupled to ensure stable generation of vibration.

As is apparent from the above description, according to a high power micro-speaker of the present invention, a voice coil having passed through an opening perforated in a damper plate is attached to a lower surface of a center dome part of a vibrating plate located above the damper plate, which can increase a vibrating region, required for movement of the voice coil, by a thickness of the damper plate.

According to the present invention, since the voice coil passes through the opening of the damper plate to thereby be attached to the lower surface of the center dome part located above the damper plate, there is no risk in that an adhesive or adhesive pellets between the voice coil and the center dome part the thickness of the damper plate deviate from a thickness range of the damper plate, which can increase a vibrating region required for movement of the damper plate.

Further, according to the present invention, by providing an increased vibrating region for movement of the voice coil and the damper plate and by increasing a height of the voice coil or the magnet in proportion to the increased vibrating region, it is possible to achieve greater output power than conventional micro-speakers.

Furthermore, according to the present invention, by providing an increased vibrating region for movement of the voice coil and the damper plate and by decreasing a height of the frame in proportion to the increased vibrating region, it is possible to achieve a slimmer design than conventional micro-speakers.

In addition, according to the present invention, as a result of connecting a lead wire of the voice coil to an upper surface of the damper plate during assembly of a vibrating module, an easier lead wire connection process and automation of production can be accomplished.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A high power micro-speaker comprising:
a frame;
a magnetic field generator installed within the frame and having an air gap;
a vibrating plate consisting of an edge part and a center dome part, the vibrating plate being adapted to vibrate via operation of a voice coil located in the air gap; and
a damper plate having a center opening through which the voice coil vertically pass, an inner peripheral end fixed to the vibrating plate to ensure stable vibration of the vibrating plate, and an outer peripheral end fixed to the frame,
wherein the voice coil passes through the opening of the damper plate to thereby be attached to a lower surface of the vibrating plate that is located above the damper plate.

2. A high power micro-speaker comprising:
a frame;
a magnetic field generator installed within the frame and having an air gap;
a vibrating plate consisting of an edge part and a center dome part, the vibrating plate being adapted to vibrate via operation of a voice coil located in the air gap; and
a damper plate having a center opening through which the voice coil vertically pass, an inner peripheral end fixed to the vibrating plate to ensure stable vibration of the vibrating plate, an outer peripheral end fixed to the frame, and an aperture formed between the outer peripheral end and the inner peripheral end,
wherein the voice coil passes through the opening of the damper plate to thereby be attached to a lower surface of the vibrating plate that is located above the damper plate,
wherein the center dome part is fixed above the opening of the damper plate to close the opening, and
wherein the edge part is installed to close the aperture formed between the inner peripheral end and the outer peripheral end of the damper plate.

3. A high power micro-speaker comprising:
a frame;
a magnetic field generator installed within the frame and having an air gap;
a vibrating plate consisting of an edge part and a center dome part, the vibrating plate being adapted to vibrate via operation of a voice coil located in the air gap; and
a damper plate having a center opening through which the voice coil vertically pass, an inner peripheral end fixed to the vibrating plate to ensure stable vibration of the vibrating plate, an outer peripheral end fixed to the frame, and an aperture formed between the outer peripheral end and the inner peripheral end,
wherein the voice coil passes through the opening of the damper plate to thereby be attached to a lower surface of the vibrating plate that is located above the damper plate, and
wherein the center dome part is fixed above the opening of the damper plate to close the opening, and
wherein an outer peripheral end of the edge part is fixed to the frame, and an inner peripheral end of the edge part is attached to a lower surface of the damper plate so as to close the aperture formed in the damper plate.

4. The high power micro-speaker according to claim 2,
wherein the center dome part includes an upwardly protruding dome portion and an edge rim,
wherein the upwardly protruding dome portion of the center dome part passes through the opening of the damper plate to thereby protrude upward from the damper plate, and
wherein the rim is attached to the lower surface of the damper plate.

5. The high power micro-speaker according to claim 3,
wherein the center dome part includes an upwardly protruding dome portion and an edge rim,
wherein the upwardly protruding dome portion of the center dome part passes through the opening of the damper plate to thereby protrude upward from the damper plate, and
wherein the rim is attached to the lower surface of the damper plate.

6. The high power micro-speaker according to claim 2, wherein the center dome part has a plurality of lead wire holes formed in an outer periphery thereof to guide a lead wire of the voice coil so as to prevent the lead wire from being interposed between the center dome part and the voice coil.

7. The high power micro-speaker according to claim 3, wherein the center dome part has a plurality of lead wire holes formed in an outer periphery thereof to guide a lead wire of the voice coil so as to prevent the lead wire from being interposed between the center dome part and the voice coil.

8. An assembly method of a micro-speaker, the method comprising assembling a vibrating module including a vibrating plate that consists of an edge part and a center dome part, a voice coil, and a damper plate,
wherein assembling the vibrating module includes:
mounting the damper plate and the voice coil onto a jig such that the voice coil passes through an opening of the damper plate so as to be placed on the same plane as an upper surface of the damper plate;
applying an adhesive to an upper surface of the voice coil;
placing the center dome part on the upper surfaces of the voice coil and the damper plate; and
applying pressure to the center dome part so as to integrally attach the center dome part to the voice coil and the damper plate.

9. The assembly method of the micro-speaker according to claim 8, wherein the vibrating module is completely assembled as a lead wire of the voice coil is pulled upward from the damper plate through a lead wire hole formed in an edge of the center dome part and is connected to a connection pad formed on the upper surface of the damper plate.

10. An assembly method of a micro-speaker comprising a vibrating plate that consists of an edge part and a center dome part, a voice coil, and a damper plate, the assembly method comprising:
a frame molding operation of molding a frame such that the frame has open upper and lower ends and is provided with a cover coupling protrusion, a stepped portion configured to support the damper plate, and a stepped portion configured to support a magnetic field generator;
a vibrating module fixing operation of mounting the damper plate and the voice coil onto a jig such that the voice coil passes through an opening of the damper plate so as to be placed on the same plane as an upper surface of the damper plate, applying an adhesive to an upper surface of the voice coil, placing the center dome part on the upper surfaces of the voice coil and the damper plate, applying pressure to the center dome part so as to integrally attach the center dome part to the voice coil and the damper plate, and fixing the damper plate of the assembled vibrating module and an outer peripheral end of the edge part to the frame;
a magnetic field generator fixing operation of fixing an upper plate, a magnet and a yoke (or a lower plate) to a lower end of the frame; and
a cover fixing operation of fixing a cover to a cover coupling protrusion.
